(19) United States
(12) Patent Application Publication
(10) Pub. No.: US 2025/0045612 A1
(43) Pub. Date: Feb. 6, 2025

(54) SYSTEM AND METHOD FOR GENERATING TIME SERIES FORECASTS BASED ON PROBABILISTIC DATA

(71) Applicant: JPMorgan Chase Bank, N.A., New York, NY (US)

(72) Inventors: Peyman TAVALLALI, Monroe Township, NJ (US); Berowne HLAVATY, Caringbah (AU); Amit VARSHNEY, Fremont, CA (US); Leonard EUN, Lafayette, CA (US); Savinay NARENDRA, San Jose, CA (US); Dushyant SAHOO, Foster City, CA (US); Arundeep CHINTA, Sunnyvale, CA (US); Peng CHENG, Purchase, NY (US)

(73) Assignee: JPMorgan Chase Bank, N.A., New York, NY (US)

(21) Appl. No.: 18/792,009

(22) Filed: Aug. 1, 2024

Related U.S. Application Data
(60) Provisional application No. 63/530,459, filed on Aug. 2, 2023.

(51) Int. Cl. G06N 7/01

(52) U.S. Cl. CPC G06N 7/01

(57) ABSTRACT

System and method for generating time series forecasts based on probabilistic data are disclosed. A processor receives a request to identify at least one feature of a dataset that is most closely correlated to a single feature specified in the received request. The dataset includes the probabilistic data of the time series. The processor identifies a set of original features within the dataset and derives a degree of dependency between a single specified feature and each original feature by using a temporally first portion of the dataset. After deriving a degree of dependency between all the features including the single specified feature and each engineered feature of the set of original features, the processor identifies an original feature or an engineered feature with the highest degree of dependency as the at least one feature of the dataset that is most closely dependent to the single specified feature.

### CROSS-REFERENCE TO RELATED APPLICATIONS

This application claims the benefit of priority from U.S. Provisional Patent Application No. 63/530,459, filed Aug. 2, 2023, which is herein incorporated by reference in its entirety.

### TECHNICAL FIELD

This disclosure generally relates to data processing, and, more particularly, to methods and apparatuses for implementing a platform, language, cloud, and database agnostic time series forecasts generating module configured to generate time series forecasts based on probabilistic data.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Time-series forecasts in financial markets may prove to be very difficult. Depending on what one may be trying to forecast, there appears to be a lot of noise masking any signal, which may often be influenced by many external drivers. To further complicate the situation, often the external drivers (e.g., inflation) may change through time and so there may be a time varying component to these relationships.

In the field of generating time series forecasts based on deterministic data, there have long been a plethora of well-established and characterized processing tools for deriving meaningful insights and generating forecasts from deterministic data with a practical degree of accuracy. However, where the data is not deterministic and/or where there are other conditions that thwart the generation of deterministic forecasts, there appears to be a relative lack of such well-established and characterized processing tools.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic time series forecasts generating module configured to implement machine learning models and techniques to output time series forecasts based on probabilistic data, but the disclosure is not limited thereto.

In some embodiments, a method for generating a probabilistic time series forecast based on stochastic data by utilizing one or more processors along with allocated memory is disclosed. The method may include: receiving, from a requesting device, a request to identify at least one feature of a dataset that is most closely correlated to a single feature specified in the received request, wherein the dataset may include the probabilistic data of the time series; identifying a set of original features that are present within the dataset; deriving a set of engineered features based on the set of original features; deriving a degree of dependency between the single specified feature and each original feature of the set of original features by using a temporally first portion of the dataset; deriving a degree of dependency between all the features including the single specified feature and each engineered feature of the set of original features by using the first portion of the dataset; identifying, based on the degree of dependency associated with each original feature of the set of original features and associated with each engineered feature of the set of engineered features, an original feature or an engineered feature associated with the highest degree of dependency as the at least one feature of the dataset that is most closely dependent to the single specified feature; and transmitting, to the requesting device, an indication of the at least one feature.

In some embodiments, the method may further include: analyzing the received request to determine whether the received request includes a request to identify a combination of a probabilistic model based on machine learning (ML) and a set of hyperparameters as most optimized for generating a forecast for the single specified feature from among a set of combinations of ML-based probabilistic models and corresponding hyperparameters.

In some embodiments, the method may further include: determining that the received request includes a request to identify a combination of a probabilistic model based on ML and a set of hyperparameters as most optimized for generating a forecast for the single specified feature from among the set of combinations.

In some embodiments, the method may further include: testing each combination of an ML-based probabilistic model and corresponding hyperparameters of the set of combinations to identify a combination of ML-based probabilistic model and corresponding hyperparameters that is the most optimized among the set of combinations; and transmitting, to the requesting device, an indication of the combination that is the most optimized among the set of combinations.

In some embodiments, the method may further include: analyzing the received request to determine whether the received request includes a request to generate the probabilistic forecast for the single specified feature; and in response to a determination that the received request includes a request to generate the forecast, performing operations that may include: generating the forecast for the single specified feature, wherein the forecast specifies a probability distribution; and transmitting, to the requesting device, an indication of the combination that is the most optimized among the set of combinations.

In some embodiments, a system for generating a probabilistic time series forecast based on stochastic data is disclosed. The system may include: a processor; and a memory operatively connected to the processor via a communication interface, the memory storing computer readable instructions, when executed, may cause the processor to: receive, from a requesting device, a request to identify at least one feature of a dataset that is most closely correlated to a single feature specified in the received request, wherein the dataset comprises the probabilistic data of the time series; identify a set of original features that are present within the dataset; derive a set of engineered features based on the set of original features; derive a degree of dependency between the single specified feature and each original feature of the set of original features by using a temporally first portion of the dataset; derive a degree of dependency between all the features including the single specified feature and each engineered feature of the set of original features by using the first portion of the dataset; identify, based on the degree of dependency associated with each original feature of the set of original features and associated with each engineered feature of the set of engineered features, an original feature or an engineered feature associated with the highest degree of dependency as the at least one feature of the dataset that is most closely dependent to the single specified feature; and transmit, to the requesting device, an indication of the at least one feature.

In some embodiments, the processor may be further configured to: analyze the received request to determine whether the received request includes a request to identify a combination of a probabilistic model based on machine learning (ML) and a set of hyperparameters as most optimized for generating a forecast for the single specified feature from among a set of combinations of ML-based probabilistic models and corresponding hyperparameters.

In some embodiments, in training the data model, the processor may be further configured to: determine that the received request includes a request to identify a combination of a probabilistic model based on ML and a set of hyperparameters as most optimized for generating a forecast for the single specified feature from among the set of combinations.

In some embodiments, the processor may be further configured to: test each combination of an ML-based probabilistic model and corresponding hyperparameters of the set of combinations to identify a combination of ML-based probabilistic model and corresponding hyperparameters that is the most optimized among the set of combinations; and transmit, to the requesting device, an indication of the combination that is the most optimized among the set of combinations.

In some embodiments, the processor may be further configured to: analyze the received request to determine whether the received request includes a request to generate the probabilistic forecast for the single specified feature; and in response to a determination that the received request includes a request to generate the forecast, the processor may be further configured to: generate the forecast for the single specified feature, wherein the forecast specifies a probability distribution; and transmits, to the requesting device, an indication of the combination that is the most optimized among the set of combinations.

In some embodiments, a non-transitory computer readable medium configured to store instructions for generating a probabilistic time series forecast based on stochastic data is disclosed. The instructions, when executed, may cause a processor to perform the following: receiving, from a requesting device, a request to identify at least one feature of a dataset that is most closely correlated to a single feature specified in the received request, wherein the dataset may include the probabilistic data of the time series; identifying a set of original features that are present within the dataset; deriving a set of engineered features based on the set of original features; deriving a degree of dependency between the single specified feature and each original feature of the set of original features by using a temporally first portion of the dataset; deriving a degree of dependency between all the features including the single specified feature and each engineered feature of the set of original features by using the first portion of the dataset; identifying, based on the degree of dependency associated with each original feature of the set of original features and associated with each engineered feature of the set of engineered features, an original feature or an engineered feature associated with the highest degree of dependency as the at least one feature of the dataset that is most closely dependent to the single specified feature; and transmitting, to the requesting device, an indication of the at least one feature.

In some embodiments, the instructions, when executed, may cause the processor to further perform the following: analyzing the received request to determine whether the received request includes a request to identify a combination of a probabilistic model based on ML and a set of hyperparameters as most optimized for generating a forecast for the single specified feature from among a set of combinations of ML-based probabilistic models and corresponding hyperparameters.

In some embodiments, the instructions, when executed, may cause the processor to further perform the following: determining that the received request includes a request to identify a combination of a probabilistic model based on ML and a set of hyperparameters as most optimized for generating a forecast for the single specified feature from among the set of combinations.

In some embodiments, the instructions, when executed, may cause the processor to further perform the following: testing each combination of an ML-based probabilistic model and corresponding hyperparameters of the set of combinations to identify a combination of ML-based probabilistic model and corresponding hyperparameters that is the most optimized among the set of combinations; and transmitting, to the requesting device, an indication of the combination that is the most optimized among the set of combinations.

In some embodiments, the instructions, when executed, may cause the processor to further perform the following: analyzing the received request to determine whether the received request includes a request to generate the probabilistic forecast for the single specified feature; and in response to a determination that the received request includes a request to generate the forecast, performing operations that may include: generating the forecast for the single specified feature, wherein the forecast specifies a probability distribution; and transmitting, to the requesting device, an indication of the combination that is the most optimized among the set of combinations.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic time series forecasts generating module configured to systemically and dynamically generate time series forecasts based on probabilistic data in accordance with an embodiment.

FIG. 2 illustrates a diagram of a network environment with a platform, language, database, and cloud agnostic time series forecasts generating device in accordance with an embodiment.

FIG. 3 illustrates a system diagram for implementing a platform, language, database, and cloud agnostic time series forecasts generating device having a platform, language, database, and cloud agnostic time series forecasts generating module in accordance with an embodiment.

FIG. 4 illustrates a system diagram for implementing a platform, language, database, and cloud agnostic time series forecasts generating module of FIG. 3 in accordance with an embodiment.

FIG. 5 illustrates a system for the efficient generation of probabilistic time series forecasts by implementing by the platform, language, database, and cloud agnostic time series forecasts generating module of FIG. 4 in accordance with an embodiment.

FIGS. 6A and 6B, taken together, illustrate aspects of responding to a received request for a probabilistic time series forecast, the generation of a probabilistic model incorporating ML for generating such forecasts, or for the generation of precursors to the generation of such a model in accordance with an embodiment.

FIG. 7 illustrates a flow chart of a process implemented by the platform, language, database, and cloud agnostic time series forecasts generating module of FIG. 4 for systemically and dynamically generating time series forecasts based on probabilistic data in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

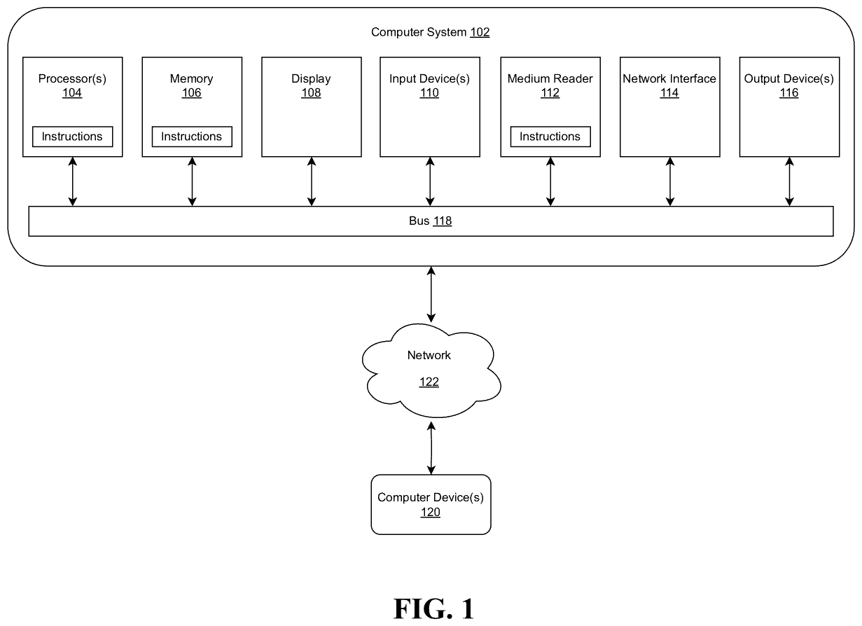

FIG. 1 is an exemplary system 100 for use in implementing a platform, language, database, and cloud agnostic time series forecasts generating module configured to systemically and dynamically generate time series forecasts based on probabilistic data in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the time series forecasts generating module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the time series forecasts generating module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

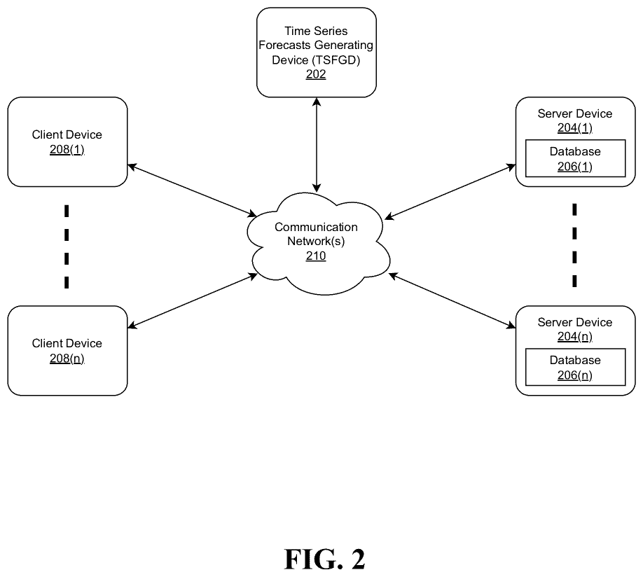

Referring to FIG. 2, a schematic of an exemplary network environment 200 for implementing a language, platform, database, and cloud agnostic time series forecasts generating device (TSFGD) of the instant disclosure is illustrated.

In some embodiments, the above-described problems associated with conventional tools may be overcome by implementing an TSFGD 202 as illustrated in FIG. 2 that may be configured for implementing a platform, language, database, and cloud agnostic time series forecasts generating module configured to implement machine learning models and techniques to generate time series forecasts based on probabilistic data, but the disclosure is not limited thereto.

The TSFGD 202 may have one or more computer system 102s, as described with respect to FIG. 1, which in aggregate provide the necessary functions.

The TSFGD 202 may store one or more applications that may include executable instructions that, when executed by the TSFGD 202, cause the TSFGD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the TSFGD 202 itself, may be located in virtual server(s) running in a cloud-based computing environment rather than being tied to one or more specific physical network computing devices. Also, the application(s) may be running in one or more virtual machines (VMs) executing on the TSFGD 202. Additionally, in one or more embodiments of this technology, virtual machine(s) running on the TSFGD 202 may be managed or supervised by a hypervisor.

In the network environment 200 of FIG. 2, the TSFGD 202 may be coupled to a plurality of server devices 204(1)-204(n) that hosts a plurality of databases 206(1)-206(n), and also to a plurality of client devices 208(1)-208(n) via communication network(s) 210. A communication interface of the TSFGD 202, such as the network interface 114 of the computer system 102 of FIG. 1, operatively couples and communicates between the TSFGD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the TSFGD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The TSFGD 202 may be a standalone device or integrated with one or more other devices or apparatuses, such as one or more of the server devices 204(1)-204(n). In some embodiments, the TSFGD 202 may be hosted by one of the server devices 204(1)-204(n), and other arrangements may also be possible. Moreover, one or more of the devices of the TSFGD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the TSFGD 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the TSFGD 202 that may efficiently provide a platform for implementing a platform, language, database, and cloud agnostic time series forecasts generating module configured to implement machine learning models and techniques to generate time series forecasts based on probabilistic data, but the disclosure is not limited thereto.

The client devices 208(1)-208(n) may run interface applications, such as standard web browsers or standalone client applications, which may provide an interface to communicate with the TSFGD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the TSFGD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the TSFGD 202, the server devices 204(1)-204(n), or the client devices 208(1)-208(n), in some embodiments, may be configured to operate as virtual instances on the same physical machine. In some embodiments, one or more of the TSFGD 202, the server devices 204(1)-204(n), or the client devices 208(1)-208(n) may operate on the same physical device rather than as separate devices communicating through communication network(s) 210. Additionally, there may be more or fewer TSFGDs 202, server devices 204(1)-204(n), or client devices 208(1)-208(n) than illustrated in FIG. 2. In some embodiments, the TSFGD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

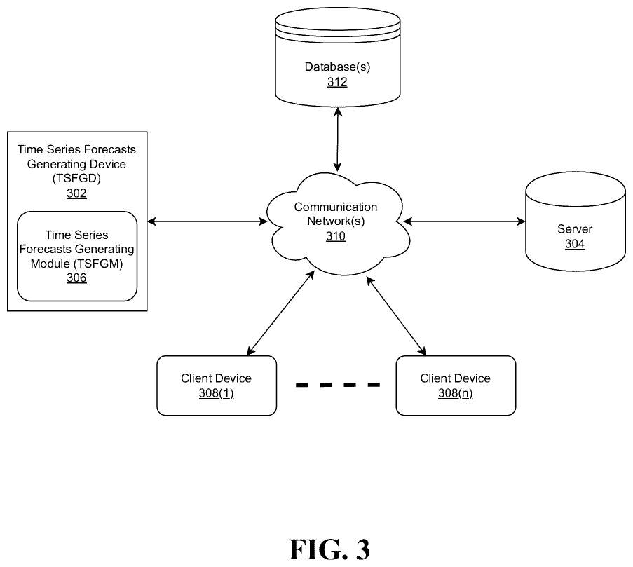

FIG. 3 illustrates a system diagram for implementing a platform, language, and cloud agnostic TSFGD having a platform, language, database, and cloud agnostic time series forecasts generating module (TSFGM) in accordance with an embodiment.

As illustrated in FIG. 3, the system 300 may include an TSFGD 302 within which an TSFGM 306 may be embedded, a server 304, a database(s) 312, a plurality of client devices 308(1) . . . 308(n), and a communication network 310.

In some embodiments, the TSFGD 302 including the TSFGM 306 may be connected to the server 304, and the database(s) 312 via the communication network 310. The TSFGD 302 may also be connected to the plurality of client devices 308(1) . . . 308(n) via the communication network 310, but the disclosure is not limited thereto.

According to exemplary embodiment, the TSFGD 302 is described and shown in FIG. 3 as including the TSFGM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the TSFGM 306 may be configured to receive real-time feed of data from the plurality of client devices 308(1) . . . 308(n) and secondary sources via the communication network 310.

As may be described below, the TSFGM 306 may be configured for: receiving, from a requesting device, a request to identify at least one feature of a dataset that may be most closely correlated to a single feature specified in the received request, wherein the dataset may comprise the probabilistic data of the time series; identifying a set of original features that are present within the dataset; based on the set of original features, deriving a set of engineered features; using a temporally first portion of the dataset to derive a degree of dependency between the single specified feature and each original feature of the set of original features; using the first portion of the dataset to derive a degree of dependency between all the features including the single specified feature and each engineered feature of the set of original features; based on the degree of dependency associated with each original feature of the set of original features and associated with each engineered feature of the set of engineered features, identifying an original feature or an engineered feature associated with a highest degree of dependency as the at least one feature of the dataset that is most closely dependent to the single specified feature; and transmitting, to the requesting device, an indication of the at least one feature, but the disclosure is not limited thereto.

The plurality of client devices 308(1) . . . 308(n) are illustrated as being in communication with the TSFGD 302. In this regard, the plurality of client devices 308(1) . . . 308(n) may be “clients” (e.g., customers) of the TSFGD 302 and are described herein as such. Nevertheless, it is to be known and understood that the plurality of client devices 308(1) . . . 308(n) need not necessarily be “clients” of the TSFGD 302, or any entity described in association therewith herein. Any additional or alternative relationship may exist between either or both of the plurality of client devices 308(1) . . . 308(n) and the TSFGD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the TSFGD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The TSFGD 302 may be the same or similar to the TSFGD 202 as described with respect to FIG. 2, including any features or combination of features described with respect thereto.

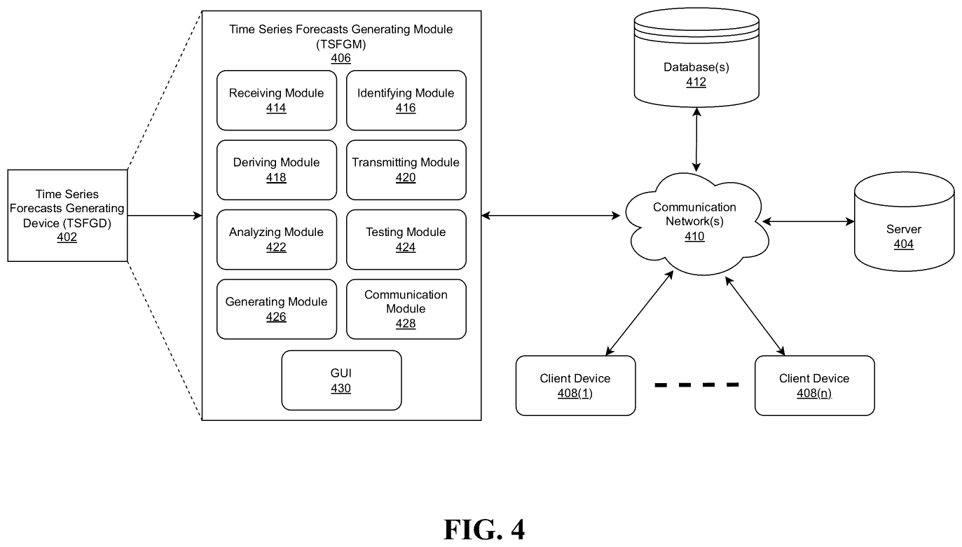

FIG. 4 illustrates a system diagram for implementing a platform, language, database, and cloud agnostic TSFGM of FIG. 3 in accordance with an exemplary embodiment.

In recent years, the use of ML-based probabilistic models has shown promise in providing processing tools of sufficient capability as to enable the generation of probabilistic time series forecasts based on stochastic data with a practical degree of accuracy similar to what has become customary for time series forecasts based on deterministic data.

However, the work of actually deriving an ML-based probabilistic model for such purposes remains a time-intensive and resource-intensive process. Extremely large datasets are often needed for deriving, training and/or testing an ML-based probabilistic model, and such large datasets may not be available. As a result, the use of random sampling techniques may be necessary to create the requisite amount of data. Also, a relatively large quantity and variety of candidate features is often evaluated to identify a subset of original and/or engineered features that correlate relatively closely with the feature for which a forecast is to be made. Further, a relatively large quantity of candidate models is often evaluated, along with numerous candidate sets of hyperparameters for each of those models.

The present disclosure addresses the foregoing by providing a method, system, and computer program product for the efficient generation of at least the precursors for ML-based probabilistic models, and/or for the use of those models to generate probabilistic time series forecasts. A probabilistic forecasting routine may include multiple modules of executable instructions that may each be callable to be executed in varying combinations in response to what is requested in a received request. Such received requests may include a request for various precursors to an ML-based probabilistic model, a request for the model, itself, and/or a request for a probabilistic time series forecast based on the model.

Such requested precursors may include a subset of the candidate features that are found to correlate relatively closely with the feature for which a forecast is to be generated, may include a selection of the type of ML-based probabilistic model to be used in generating a forecast, and/or a set of hyperparameters that are to be used to configure the selected model for generating a forecast. Where there is a received request for the provision of precursors, but not to generate a forecast, the contents of the received request may be analyzed to determine what subset of the modules of the probabilistic forecasting routine are to be executed to provide a response to the received request.

Regardless of whether the received request includes the generation of a forecast, the execution of at least one of the modules in answer to the received request may entail the use of the processing resources of a relatively large quantity of processors of numerous processing devices, and/or of a relatively large quantity of processor cores within fewer processing devices incorporating at least one multi-core CPU or at least one GPU. The response to a received request may include various graphical plots that may be generated through the selective execution of still further modules of the probabilistic forecasting routine.

Regardless of the exact contents of a response, it may be that indications of details of each received request and associated response may be stored within a results cache. This may enable future received requests that are identical to an earlier received request and/or that require the generation of at least some of the same precursors to be at least partially responded to using information stored within the results cache. In this way, repeat performances of the generation of previously generated precursors to models, previously generated models, and/or previously generated forecasts may be avoided. The preservation of such contents of the results cache may be subject to a pre-determined upper limitation on the age thereof.

In this manner, the generation of a probabilistic time series forecast and/or the generation of precursors therefor may be performed in a more efficient manner.

In some embodiments, the system 400 may include a platform, language, database, and cloud agnostic TSFGD 402 within which a platform, language, database, and cloud agnostic TSFGM 406 may be embedded, a server 404, database(s) 412, and a communication network 410. In some embodiments, server 404 may comprise a plurality of servers located centrally or located in different locations, but the disclosure is not limited thereto.

In some embodiments, the TSFGD 402 including the TSFGM 406 may be connected to the server 404, the communication channels 403, and the database(s) 412 via the communication network 410. The TSFGD 402 may also be connected to the plurality of client devices 408(1)-408(n) via the communication network 410, but the disclosure is not limited thereto. The TSFGM 406, the server 404, the plurality of client devices 408(1)-408(n), the database(s) 412, the communication network 410 as illustrated in FIG. 4 may be the same or similar to the TSFGM 306, the server 304, the plurality of client devices 308(1)-308(n), the database(s) 312, the communication network 310, respectively, as illustrated in FIG. 3.

In some embodiments, as illustrated in FIG. 4, the TSFGM 406 may include a receiving module 414, an identifying module 416, a deriving module 418, a transmitting module 420, an analyzing module 422, a testing module 424, a generating module 426, a communication module 428, and a Graphical User Interface (GUI) 430. In some embodiments, interactions and data exchange among these modules included in the TSFGM 406 provide the advantageous effects of the disclosed invention. Functionalities of each module of FIG. 4 may be described in detail below with reference to FIGS. 4-7.

In some embodiments, each of the receiving module 414, identifying module 416, deriving module 418, transmitting module 420, analyzing module 422, testing module 424, generating module 426, and the communication module 428 of the TSFGM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the receiving module 414, identifying module 416, deriving module 418, transmitting module 420, analyzing module 422, testing module 424, generating module 426, and the communication module 428 of the TSFGM 406 of FIG. 4 may be implemented by microprocessors or similar, and may be programmed using software (e.g., microcode) to perform various functions discussed herein and may optionally be driven by firmware and/or software.

Alternatively, in some embodiments, each of the receiving module 414, identifying module 416, deriving module 418, transmitting module 420, analyzing module 422, testing module 424, generating module 426, and the communication module 428 of the TSFGM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the TSFGM 406 of FIG. 4 may also be implemented by Cloud based deployment.

In some embodiments, each of the receiving module 414, identifying module 416, deriving module 418, transmitting module 420, analyzing module 422, testing module 424, generating module 426, and the communication module 428 of the TSFGM 406 of FIG. 4 may be called via corresponding API, but the disclosure is not limited thereto. In some embodiments, calls may also be made using Event based message interfaces in addition to APIs.

In some embodiments, the process implemented by the TSFGM 406 may be executed via the communication module 428 and the communication network 410, which may comprise plural networks as described above. In some embodiments, in an exemplary embodiment, the various components of the TSFGM 406 may communicate with the server 404, and the database(s) 412 via the communication module 428 and the communication network 410 and the results may be displayed onto the GUI 430. Of course, these embodiments are merely exemplary and are not limiting or exhaustive. The database(s) 412 may include the databases included within the private cloud and/or public cloud and the server 404 may include one or more servers within the private cloud and the public cloud.

In some embodiments, the receiving module 414 may be configured to receive, from a requesting device (i.e., client device 408(1)), a request to identify at least one feature of a dataset that may be most closely correlated to a single feature specified in the received request. The dataset may comprise the probabilistic data of the time series.

In some embodiments, the identifying module 416 may be configured to identify a set of original features that are present within the dataset. Based on the set of original features, the deriving module 418 may be configured to derive a set of engineered features. Using a temporally first portion of the dataset to derive a degree of dependency between the single specified feature and each original feature of the set of original features. Using the first portion of the dataset to derive a degree of dependency between all the features including the single specified feature and each engineered feature of the set of original features.

In some embodiments, based on the degree of dependency associated with each original feature of the set of original features and associated with each engineered feature of the set of engineered features, the identifying module 416 may be configured to identify an original feature or an engineered feature associated with the highest degree of dependency as the at least one feature of the dataset that is most closely dependent to the single specified feature. The transmitting module 420 may be configured to transmit, to the requesting device, an indication of the at least one feature.

In some embodiments, the analyzing module 422 may be configured to analyze the received request to determine whether the received request includes a request to identify a combination of a probabilistic model based on ML and a set of hyperparameters as most optimized for generating a forecast for the single specified feature from among a set of combinations of ML-based probabilistic models and corresponding hyperparameters.

In response to a determination that the received request includes a request to identify a combination of a probabilistic model based on ML and a set of hyperparameters as most optimized for generating a forecast for the single specified feature from among the set of combinations, performing operations comprising: testing, by utilizing the testing module 424, each combination of an ML-based probabilistic model and corresponding hyperparameters of the set of combinations to identify a combination of ML-based probabilistic model and corresponding hyperparameters that is the most optimized among the set of combinations; and transmitting, by utilizing the transmitting module 420, to the requesting device, an indication of the combination that is the most optimized among the set of combinations.

In some embodiments, the analyzing module 422 may be further configured to analyze the received request to determine whether the received request includes a request to generate the probabilistic forecast for the single specified feature. In response to a determination that the received request includes a request to generate the forecast, performing operations comprising: generating, by utilizing the generating module 426, the forecast for the single specified feature, wherein the forecast may specify a probability distribution; and transmitting, by utilizing the transmitting module 420, to the requesting device, an indication of the combination that is the most optimized among the set of combinations.

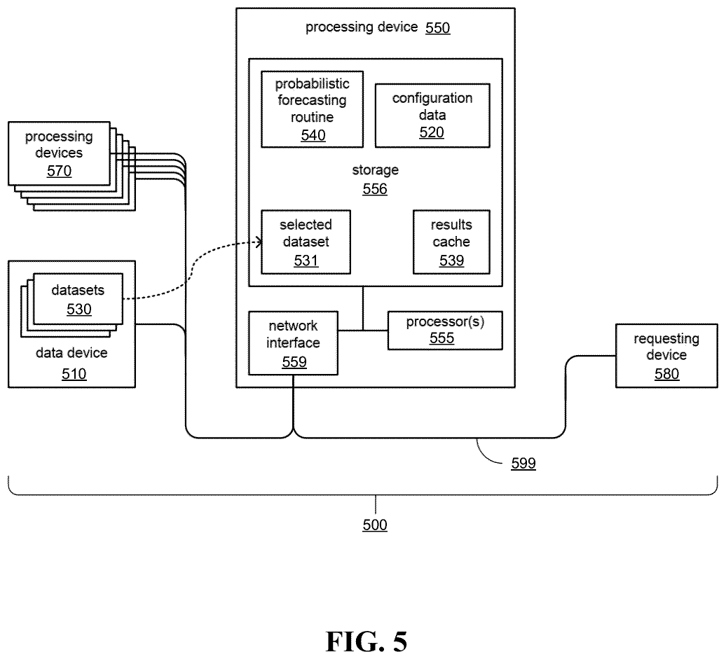

FIG. 5 illustrates a system for the efficient generation of probabilistic time series forecasts by implementing by the platform, language, database, and cloud agnostic TSFGM 406 of FIG. 4 in accordance with an embodiment. FIG. 5 illustrates a block diagram of a system 500 in which various portions of a probabilistic forecasting routine 540 may be selectively executed to generate responses to received requests for probabilistic time series forecasts, for ML-based probabilistic models for the generation of such forecasts, and/or for various precursors to the generation of such models.

In some embodiments, the system 500 may include a processing device 550, a data device 550, multiple processing devices 570, and/or at least one requesting device 580 that are coupled via a network 599.

The data device 550 may serve as a repository of multiple datasets 530 that are accessible to the processing device 550 via the network 599. The data within each data set 530 may cover any of a variety of subjects, including and not limited to, various fields of sciences (e.g., particle physics, geology, meteorology, etc.), various fields of engineering (e.g., aircraft design, automotive design, semiconductor device design, etc.), various societal fields of study (e.g., economic, behavior of individuals during emergencies, etc.), and/or various fields of study of wildlife (e.g., animal migration patterns, animal populations, etc.). While the data within some of the datasets 530 may be deterministic, the data within others of the datasets 530 may be stochastic such that at least a subset of the data therein may include samples of probability distributions and/or other data values subject to some form of uncertainty.

The processing devices 570 may, together, form a grid, cluster, or other set of processing devices 570 among which multiple instances of a set of executable instructions of an executable routine (or executable instructions of a portion of a routine) may be executed to perform multiple instances of a task in a distributed manner. Such distributed execution may be controlled and/or coordinated through the network 599 by the processing device 550. It may be that each of the processing devices 570 includes multiple processors and/or at least one processor having multiple processing cores that allow multiple instances of such a set of executable instructions to be executed therein. In support of such multiple instances per processing device 570, it may be that multiple containers and/or multiple virtual machines (VMs) are instantiated within each processing device to provide multiple separate execution environments therein.

In some embodiments, the requesting device 580 may serve as a remote terminal from which a request for a probabilistic time series forecast, for an ML-based probabilistic model for the generation of such a forecast, and/or for various precursors to the generation of such a model may be transmitted to the processing device 550 via the network 599. The requesting device 580 may then serve as the remote terminal at which a response to that request may be received from the processing device 550.

The processing device 550 may include at least one processor 555, a storage 556, and/or a network interface 559 that may couple the processing device 550 to the network 599. As depicted, the storage 556 may store configuration data 520, a copy of one of the datasets 530 retrieved from the data device as a selected dataset 531, a results cache 539, and/or the probabilistic forecasting routine 540.

The processing device 550 may be the computing device in which various portions of the probabilistic forecasting routine 540 are executed in response to received requests for probabilistic time series forecasts, for ML-based probabilistic model for the generation of such forecasts, and/or for precursors to the generation of such models. Again, such received requests may be received via the network 599 from other devices, such as the requesting device 580. As will shortly be explained in greater detail, upon receiving such a request, the received request may be analyzed to select a subset of multiple portions of the probabilistic forecasting routine 540 that are to be executed to generate a response to the received request that is to be transmitted back to the requesting device 580. In so doing, the execution of instructions of various ones of such portions of the probabilistic forecasting routine 540 may cause the processing device 550 to cooperate with the multiple processing devices 570 via the network 599 to perform multiple instances of a task in a distributed manner there among.

Additionally, in some implementations, indications and/or copies of responses to earlier received requests may also be stored within the results cache 539 for up to a pre-determined period of time. In this way, at least some received requests that are repetitious of earlier received requests may be responded to from the results cache, thereby obviating the need to repeat already recently performed operations to generate forecasts, models and/or precursors to models.

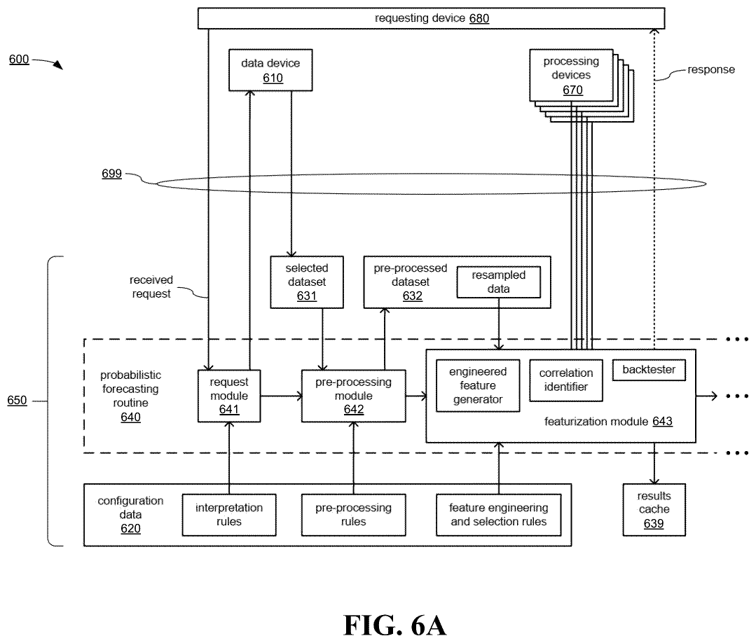

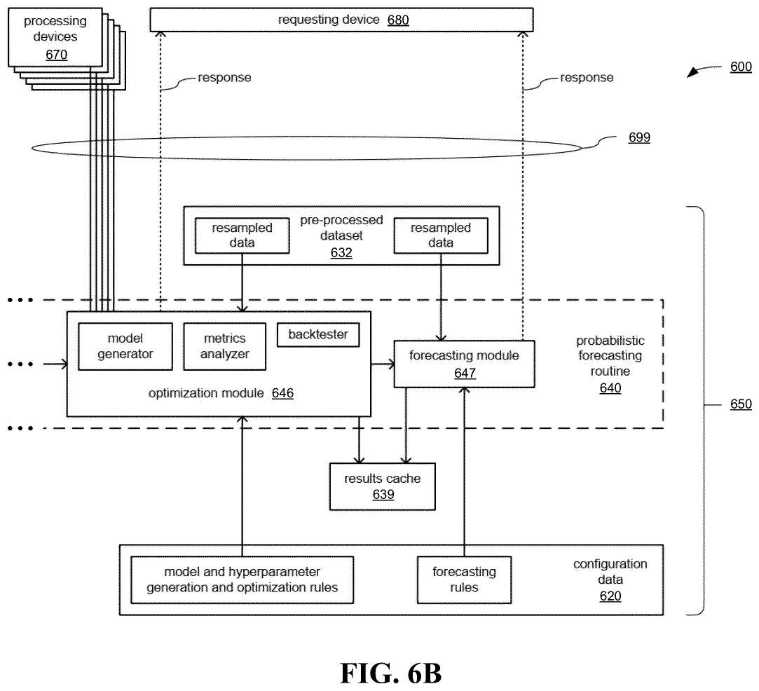

FIGS. 6A and 6B, taken together, illustrate aspects of responding to a received request for a probabilistic time series forecast, the generation of a probabilistic model incorporating ML for generating such forecasts, or for the generation of precursors to the generation of such a model in accordance with an embodiment.

As illustrated, FIGS. 6A and 6B, taken together, depict aspects of the selective execution of various portions of the probabilistic forecasting routine 640 to perform the generation of responses to received requests for probabilistic time series forecasts, for ML-based probabilistic models for the generation of such forecasts, and/or for various precursors to the generation of such models. In the example of FIGS. 6A and 6B, the probabilistic forecasting routine 640 may include a request module 641, a pre-processing module 642, a featurization module 643, an optimization module 646, and/or a forecasting module 647.

Turning to FIG. 6A, in executing instructions of the request module 641, the processor(s) 655 of the processing device 650 may be caused to monitor the network 699 for the receipt of requests from other devices, such as the request device 680. Upon receiving a such a request, the processor(s) 655 may be caused to interpret the contents thereof to determine the details of what has been requested. In so doing, the processor(s) 655 may retrieve a set of interpretation rules from the configuration data 620.

Among the details to be determined may be whether the received request is for a probabilistic time series forecast, an ML-based probabilistic model for generating such a forecast, and/or precursors for generating such a model. As will shortly be discussed in greater detail, upon determining what is requested to be included in the response to the received request, the processor(s) 655 may determine which one(s) of the featurization module 643, the optimization module 646, and/or the forecast module 647 are to be executed to generate the response thereto. The details may also include an indication of what graphs, plots, mathematical expressions, textual expressions and/or other forms of expression are to be used and/or included in the response to the received request.

Further among the details to be determined may be what dataset 630 is specified to be used as an input. In continuing to execute instructions of the request module 641, the processor(s) 655 may be caused to communicate with the data device 660, via the network 699, to retrieve the specified one of the datasets 630 therefrom as the selected data set 636. Where the received request includes a request for a forecast to be generated, the details may additionally include an indication of which feature (whether an original feature or an engineered feature) is the one for which a forecast is requested, and with what forecast horizon. Where the received request does not include a request for a forecast to be generated, the details may additionally include an indication of which feature is the one for which other relatively closely correlated features are to be identified, and/or for which a model for generating forecasts is requested.

In executing instructions of the pre-processing module 642, the processor(s) 655 of the processing device 650 may be caused to perform various pre-processing operations on the selected dataset 636 to generate a pre-processed dataset 632 therefrom. As part of performing such pre-processing operations, the processor(s) 655 may retrieve indications of rules for performing such pre-processing from the configuration data 620.

Among the pre-processing operations may be the derivation of new data values to fill in those that are missing within the selected dataset 636. Also, among such operations may be repairing or replacing NAN (not-a-number) data values that do not represent valid numbers (e.g., representations of infinity, data values divided by zero, missing data, etc.). Alternatively, or additionally, in executing instructions of the pre-processing module 642, the processor(s) 655 may be caused to perform various format conversion and/or normalization operations (e.g., conversions between types of data structure, conversions between data types, conversions between units of measure, etc.).

Depending on the size of the pre-processed dataset 632, and depending on the details of what is requested within a received request, it may be that the pre-processed dataset 632 does not include enough data values to provide multiple separate and distinct dataset portions that are each large enough for use in performing such operations as identifying correlations among features, identifying a relatively optimized combination of model and hyperparameters, and/or backtesting. Thus, in performing such operations as part of executing instructions of upcoming modules 643, 646 and/or 647, it may be that resampling is employed to generate the equivalent of dataset portions from the pre-processed dataset 632 that are sufficiently large and appropriate for probabilistic analyses and/or forecasting. By way of example, it may be that bootstrapping (a form of resampling with replacement) is the particular type of resampling that is used.

In executing instructions of the featurization module 643, the processor(s) 655 of the processing device 650 may be caused to perform feature engineering in which engineered features are generated. This may begin with the processor(s) 655 being caused to analyze the pre-processed dataset 632 to determine what original features are already present therein. Stated differently, the pre-processed dataset 632 may be analyzed to determine what original features of the subject of the pre-processed dataset 632 are represented by the data values therein (e.g., data values representing observed and/or measured numerical amounts).

Based on the determinations of what original features are already directly provided by the pre-processed dataset 632, the processor(s) 655 may be caused to derive a set of engineered features to be generated from the original features to expand the overall set of features to be considered as candidate features for use as inputs to a model. Such engineered features may include averages, weighted averages, means, medians, velocities, accelerations, doubled differences, Fourier features, etc. Some of the engineered features may include a set of data values that are each associated with a time period from among a sequence of consecutive time periods that form a time series. By way of a specific example, such engineered features may include a series of 7-day averages of data values of original features, where each of the 7-day averages is associated with one of a series of consecutive 7-day periods of time. To be clear, in this example, each data value already included in the pre-processed dataset 632 may be an original feature, and each 7-day average value that is generated from multiple ones of such original features may be an engineered feature. Thus, the resulting series of 7-day averages associated with a series of consecutive 7-day periods of time may be a series of engineered features. In determining what engineered features are to be derived from the original features, the processor(s) 655 may retrieve various feature engineering rules from the configuration data 620.

In preparation for the actual generation of the data values of the set of engineered features, the processor(s) 655 may analyze the overall size of the pre-processed dataset 632, and/or the quantities of data values that are included therein for each type of original feature, to determine whether the pre-processed dataset 632 is already sufficiently large as to enable its use without the use of resampling and/or without foregoing the generation of engineered features. More specifically, a determination may be made as to whether the pre-processed dataset 632 is sufficiently large as to be able to both directly provide sufficient quantities of its original features, and support the generation of sufficient quantities of the engineered features as to enable the identification of correlations among combinations of original and/or engineered features.

If the pre-processed dataset 632 is determined to be sufficiently large, then the generation of the set of engineered features may be based on the data values of at least a portion of the pre-processed dataset 632. However, if the pre-processed dataset 632 is determined to not be large enough, then, in some implementations, the generation of the set of engineered features will not be performed, and only the original features will be used. Alternatively, if the pre-processed dataset 632 is determined to not be large enough, then the generation of the set of engineered features may be based on data values from a new portion of the pre-processed dataset 632 that is generated using a resampling technique (e.g., bootstrapping).

Regardless of whether the set of engineered features is generated, further execution of instructions of the featurization module 643 may cause the processor(s) 655 to communicate and cooperate with the multiple processing devices 670 to arrange and control distributed and parallel performances of calculations to identify correlations among the original features and set of engineered features. More specifically, where the received request includes a request for a forecast to be generated, the received request may specify the original or engineered feature for which the forecast is to be generated. In response, the processor(s) 655 may be caused to use the multiple processing devices 670 to identify what other feature(s) are relatively closely correlated to the one specified for the forecast, out of the other original and engineered features that are being considered as candidates for use as inputs to the model that is to be generated for use in generating the forecast.

Alternatively, where the received request does not include a request for a forecast to actually be generated, the received request may still specify an original or engineered feature for which it is desired to identify what other original and/or engineered features that are closely correlated to it. It may be that the received request simply includes a request that such other closely correlated features be so identified. Or, it may be that the received request includes a request to derive an ML-based probabilistic model (with accompanying hyperparameters) that could be used to generate a forecast for a specified original or engineered feature.

It should be understood that, since the pre-processed dataset 632 is associated with a time series, different portions of the pre-processed dataset 632 may include features that are associated with different periods of time. As a result, portions of the data associated with later periods of time may include features that have dependencies on other features that are included in portions of the data associated with earlier periods of time.

Following the identification of such relatively closely correlated original and/or engineered features, still further execution of instructions of the featurization module 643 may cause the processor(s) 655 to additionally perform backtesting of those identified closely correlated features. Where the pre-processed dataset 632 was previously determined to be sufficiently large, as discussed above, then the processor(s) 655 may be caused to use a temporally different portion of the pre-processed dataset 632 to perform backtesting than was previously used identifying the closely correlated features. Such use of different portions of the pre-processed dataset 632 for these different operations may aid in avoiding overfitting.

Again, if the pre-processed dataset 632 was determined to be large enough, then resampling may not be required to provide the temporally different portion, and the temporally different portion may include engineered features, as well as original features. However, where the pre-processed dataset 632 was determined to not be large enough, then as discussed above, either the generation of engineered features may have been foregone such that the temporally different portion may not include engineered features, or resampling may be employed to generate the temporally different portion. Regardless, if back testing (if performed) reveals a need to repeat the performance of identifying closely correlated features, then the processor(s) 655 may be caused to do so.

Also following the identification of closely correlated features, indications of what original and/or engineered features were found to be closely correlated, along with an indication of what one feature they are closely correlated to, may be stored within the results cache 639 to enable such information to be retrieved and used at a later time. More specifically, where a future received request includes an explicit request for the identification of original and/or engineered features that are correlated to the same one feature, or where a future received request includes a request to generate a model and/or a forecast that requires identifying such closely correlated features, then such information may be retrieved from the results cache 639, instead of being re-derived anew. In this way, a future received request may be responded to more quickly and efficiently, and with less consumption of processing resources. Again, there may be an upper limit concerning how old such information may become before it is deemed to no longer be valid, and may be removed from the results cache 639, or at least be allowed to be overwritten therein.

If the received request includes just a request for such closely correlated original and/or engineered features, and does not also include a request for either a model or a forecast, then the processor(s) 655 may be caused to provide an indication of such closely correlated features as the response. In so doing, details provided in the received request concerning the form of the response may be used to generate the response to provide the indications of closely correlated features in whatever mathematical, textual and/or graphical form of expression is specified. In such a situation, it may be that neither of the optimization module 646 or the forecasting module 647 are executed in providing a response to the received request. However, if the received request does include a request for either a model or a forecast, then instructions of at least the optimization module 646 may be executed.

Turning to FIG. 6B, in executing instructions of the optimization module 646, the processor(s) 655 of the processing device 650 may be caused to perform various operations to identify a relatively optimized combination of an ML-based probabilistic model and accompanying hyperparameters for generating a forecast. This may begin with the processor(s) 655 being caused to retrieve indications from the configuration data of what types of ML-based probabilistic models are to be tested, and with what set(s) and/or range(s) of hyperparameter values. Continuing execution of instructions of the optimization module 646 may cause the processor(s) 655 to communicate and cooperate with the multiple processing devices 670 to arrange and control distributed and parallel performances of separately testing each differing combination of a model with a set of hyperparameters. In this way, hyperparameter optimization may be performed in a distributed manner.

In a manner similar to the previously discussed identification of closely correlated features and backtesting, the identification of a relatively optimized combination of a model and accompanying hyperparameters also relies on the use of a considerable amount of data. Again, where the pre-processed dataset 632 was previously determined to be sufficiently large, then the processor(s) 655 may be caused to use still another different portion of the pre-processed dataset 632 to perform the identification of a combination of a model and accompanying hyperparameters. Again, such use of different portions of the pre-processed dataset 632 for these different operations may aid in avoiding overfitting. However, and again, where the pre-processed dataset 632 was previously determined to not be sufficiently large, then the generation of engineered features may have been foregone, or resampling may again be employed.

As each candidate combination of ML-based probabilistic model and accompanying hyperparameters is tested, one or more probabilistic metrics may be used to rule out candidate combinations that did not meet pre-determined minimum threshold(s), and/or to identify the candidate combination that is found to be most optimized. Such metrics may include one or more metrics of coverage. In some implementations, a degree of similarity of predicted coverage to true coverage for each candidate combination may be evaluated.

Following the identification of such a relatively optimized combination of model and hyperparameters, still further execution of instructions of the optimization module 646 may cause the processor(s) 655 to additionally perform backtesting of that relatively optimized combination. If back testing reveals a need to repeat the performance of identifying a relatively optimized combination of model and hyperparameters, then the processor(s) 655 may be caused to do so.

Also following the identification of a relatively optimized combination of model and hyperparameters, indications of what combination of model and hyperparameters were engineered features were found to be most optimized from among the candidate combinations may be stored within the results cache 639 to enable such information to be retrieved and used at a later time. More specifically, where a future received request includes an explicit request for the identification of a relatively optimized combination of model and hyperparameters for generating a forecast for the same one feature, or where a future received request includes a request to generate a forecast for the same one feature, then such information may be retrieved from the results cache 639, instead of being re-derived anew. If the received request includes just a request for such a relatively optimized

combination of model and hyperparameters, and does not also include a request for a forecast, then the processor(s) 655 may be caused to provide an indication of such a relatively optimized combination as the response. Again, details provided in the received request concerning the form of the response may be used to generate the response to provide the indications of the relatively optimized combination in whatever mathematical, textual and/or graphical form of expression is specified. In such a situation, it may be that the forecasting module 647 is not executed in providing a response to the received request. However, if the received request does include a request for a forecast, then instructions of at least the forecasting module 647 may be executed.

In executing instructions of the forecasting module 647, the processor(s) 655 of the processing device 650 may be caused to generate a forecast for the one feature and the forecast horizon specified in the received request.

Following the generation of the forecast, indications of the contents of the forecast may be stored within the results cache 639 to enable such information to be retrieved and used at a later time. Also following the generation of the forecast, the processor(s) 655 may be caused to provide an indication of the forecast as the response. Again, details provided in the received request concerning the form of the response may be used to generate the response to provide the indications of the relatively optimized combination in whatever mathematical, textual and/or graphical form of expression is specified.

The storage 656 of the processing device 650 may include any of a variety of types of non-transitory computer readable storage medium implemented using any of a variety of storage technologies, including and not limited to, any electronic, magnetic, optical, or other physical storage device that stores executable instructions. For example, the storage 650 may include random access memory (RAM), an electrically-erasable programmable read-only memory (EEPROM), a storage drive, an optical disc, or the like. The storage 650 may be encoded to store executable instructions (e.g., instructions of the model maintenance routine 640) that cause a processor (e.g., the processor(s) 655) to perform operations according to examples of the disclosure.

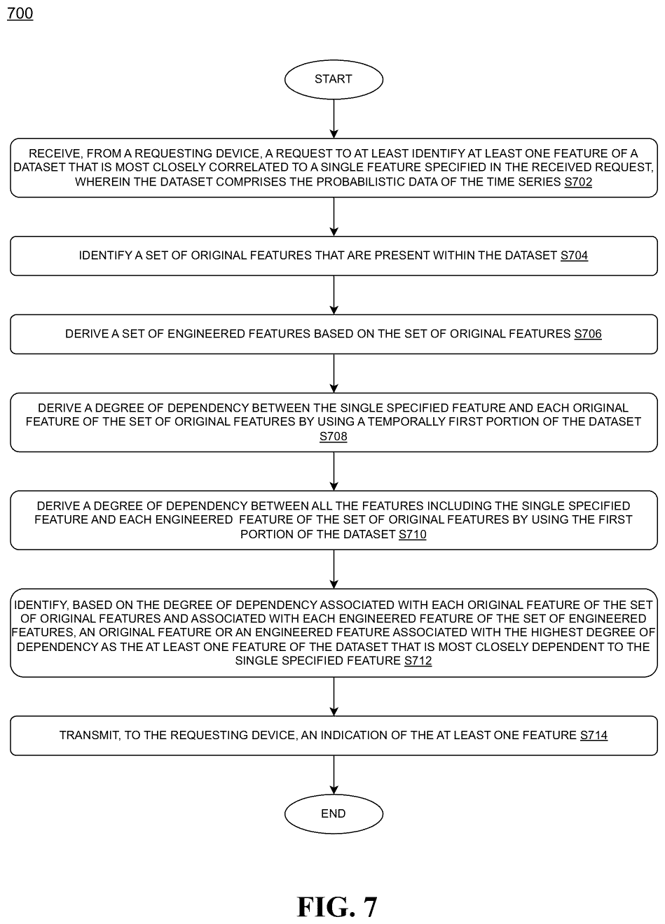

FIG. 7 illustrates an exemplary flow chart of a process 700 implemented by the platform, language, database, and cloud agnostic TSFGM 407 of FIG. 4 for systemically and dynamically generating time series forecasts based on probabilistic data in accordance with an exemplary embodiment. It may be appreciated that the illustrated process 700 and associated steps may be performed in a different order, with illustrated steps omitted, with additional steps added, or with a combination of reordered, combined, omitted, or additional steps.

As illustrated in FIG. 7, at step S702, the process 700 may include receiving, from a requesting device, a request to identify at least one feature of a dataset that is most closely correlated to a single feature specified in the received request. The dataset may comprise the probabilistic data of the time series.

At step S704, the process 700 may include identifying a set of original features that are present within the dataset.

At step S706, the process 700 may include deriving a set of engineered features based on the set of original features.

At step S708, the process 700 may include deriving a degree of dependency between the single specified feature and each original feature of the set of original features by utilizing a temporally first portion of the dataset.

At step S710, the process 700 may include deriving a degree of dependency between all the features including the single specified feature and each engineered feature of the set of original features by utilizing the first portion of the dataset.

At step S712, the process 700 may include, based on the degree of dependency associated with each original feature of the set of original features and associated with each engineered feature of the set of engineered features, identifying an original feature or an engineered feature associated with a highest degree of dependency as the at least one feature of the dataset that is most closely dependent to the single specified feature.

At step S714, the process 700 may include transmitting, to the requesting device, an indication of the at least one feature.

In some embodiments, the process 700 may further include: analyzing the received request to determine whether the received request includes a request to identify a combination of a probabilistic model based on ML and a set of hyperparameters as most optimized for generating a forecast for the single specified feature from among a set of combinations of ML-based probabilistic models and corresponding hyperparameters; and in response to a determination that the received request includes a request to identify a combination of a probabilistic model based on ML and a set of hyperparameters as most optimized for generating a forecast for the single specified feature from among the set of combinations, performing operations that may include: testing each combination of an ML-based probabilistic model and corresponding hyperparameters of the set of combinations to identify a combination of ML-based probabilistic model and corresponding hyperparameters that is the most optimized among the set of combinations; and transmitting, to the requesting device, an indication of the combination that is the most optimized among the set of combinations.

In some embodiments, the process 700 may further include: analyzing the received request to determine whether the received request includes a request to generate the probabilistic forecast for the single specified feature; and in response to a determination that the received request includes a request to generate the forecast, performing operations that may include: generating the forecast for the single specified feature, wherein the forecast specifies a probability distribution; and transmitting, to the requesting device, an indication of the combination that is the most optimized among the set of combinations.

In some embodiments, the TSFGD 402 may include a memory (e.g., a memory 106 as illustrated in FIG. 1) which may be a non-transitory computer readable medium that may be configured to store instructions for implementing a platform, language, database, and cloud agnostic TSFGM 406 for systemically and dynamically generating time series forecasts based on probabilistic data as disclosed herein. The TSFGD 402 may also include a medium reader (e.g., a medium reader 112 as illustrated in FIG. 1) which may be configured to read any one or more sets of instructions, e.g., software, from any of the memories described herein. The instructions, when executed by a processor embedded within the TSFGM 406 or within the TSFGD 402, may be used to perform one or more of the process 600 and processes as described herein. In a particular embodiment, the instructions may reside completely, or at least partially, within the memory 106, the medium reader 112, and/or the processor 104 (see FIG. 1) during execution by the TSFGD 402.

In some embodiments, the instructions, when executed, may cause a processor embedded within the TSFGM 406 or the TSFGD 402 to perform the following: receiving, from a requesting device, a request to identify at least one feature of a dataset that is most closely correlated to a single feature specified in the received request, wherein the dataset may comprise the probabilistic data of the time series; identifying a set of original features that are present within the dataset; based on the set of original features, deriving a set of engineered features; deriving a degree of dependency between the single specified feature and each original feature of the set of original features by using a temporally first portion of the dataset; deriving a degree of dependency between all the features including the single specified feature and each engineered feature of the set of original features by using the first portion of the dataset; based on the degree of dependency associated with each original feature of the set of original features and associated with each engineered feature of the set of engineered features, identifying an original feature or an engineered feature associated with a highest degree of dependency as the at least one feature of the dataset that is most closely dependent to the single specified feature; and transmitting, to the requesting device, an indication of the at least one feature. In some embodiments, the processor may be the same or similar to the processor 104 as illustrated in FIG. 1 or the processor embedded within the TSFGD 202, TSFGD 302, TSFGD 402, and TSFGM 406 which may be the same or similar to the processor 104.

In some embodiments, the instructions, when executed, may cause the processor 104 to further perform the following: analyzing the received request to determine whether the received request includes a request to identify a combination of a probabilistic model based on ML and a set of hyperparameters as most optimized for generating a forecast for the single specified feature from among a set of combinations of ML-based probabilistic models and corresponding hyperparameters; and in response to a determination that the received request includes a request to identify a combination of a probabilistic model based on ML and a set of hyperparameters as most optimized for generating a forecast for the single specified feature from among the set of combinations, performing operations that may include: testing each combination of an ML-based probabilistic model and corresponding hyperparameters of the set of combinations to identify a combination of ML-based probabilistic model and corresponding hyperparameters that is the most optimized among the set of combinations; and transmitting, to the requesting device, an indication of the combination that is the most optimized among the set of combinations.

In some embodiments, the instructions, when executed, may cause the processor 104 to further perform the following: analyzing the received request to determine whether the received request includes a request to generate the probabilistic forecast for the single specified feature; and in response to a determination that the received request includes a request to generate the forecast, performing operations that may include: generating the forecast for the single specified feature, wherein the forecast specifies a probability distribution; and transmitting, to the requesting device, an indication of the combination that is the most optimized among the set of combinations.

In some embodiments as disclosed above in FIGS. 1-7, technical improvements effected by the instant disclosure may include a platform for implementing a platform, language, database, and cloud agnostic time series forecasts generating module configured to implement machine learning models and techniques to systemically and dynamically generate time series forecasts based on probabilistic data, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, process 600, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or process 600 described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for generating a probabilistic time series forecast based on stochastic data by utilizing one or more processors along with allocated memory, the method comprising:
receiving, from a requesting device, a request to identify at least one feature of a dataset that is most closely correlated to a single feature specified in the received request, wherein the dataset comprises the probabilistic data of the time series;
identifying a set of original features that are present within the dataset;
deriving a set of engineered features based on the set of original features;
deriving a degree of dependency between the single specified feature and each original feature of the set of original features by using a temporally first portion of the dataset;
deriving a degree of dependency between all the features including the single specified feature and each engineered feature of the set of original features by using the first portion of the dataset;
identifying, based on the degree of dependency associated with each original feature of the set of original features and associated with each engineered feature of the set of engineered features, an original feature or an engineered feature associated with the highest degree of dependency as the at least one feature of the dataset that is most closely dependent to the single specified feature; and
transmitting, to the requesting device, an indication of the at least one feature.

2. The method according to claim 1, further comprising:
analyzing the received request to determine whether the received request includes a request to identify a combination of a probabilistic model based on machine learning (ML) and a set of hyperparameters as most optimized for generating a forecast for the single specified feature from among a set of combinations of ML-based probabilistic models and corresponding hyperparameters.

3. The method according to claim 2, further comprising:
determining that the received request includes a request to identify a combination of a probabilistic model based on ML and a set of hyperparameters as most optimized for generating a forecast for the single specified feature from among the set of combinations.

4. The method according to claim 3, further comprising:
testing each combination of an ML-based probabilistic model and corresponding hyperparameters of the set of combinations to identify a combination of ML-based probabilistic model and corresponding hyperparameters that is the most optimized among the set of combinations; and
transmitting, to the requesting device, an indication of the combination that is the most optimized among the set of combinations.

5. The method according to claim 2, further comprising:
analyzing the received request to determine whether the received request includes a request to generate the probabilistic forecast for the single specified feature.

6. The method according to claim 5, further comprising:
determining that the received request includes a request to generate the forecast.

7. The method according to claim 6, further comprising:
generating the forecast for the single specified feature, wherein the forecast specifies a probability distribution; and
transmitting, to the requesting device, an indication of the combination that is the most optimized among the set of combinations.

8. A system for generating a probabilistic time series forecast based on stochastic data, the system comprising:
a processor; and
a memory operatively connected to the processor via a communication interface, the memory storing computer readable instructions, when executed, causes the processor to:
receive, from a requesting device, a request to identify at least one feature of a dataset that is most closely correlated to a single feature specified in the received request, wherein the dataset comprises the probabilistic data of the time series;
identify a set of original features that are present within the dataset;
derive a set of engineered features based on the set of original features;
derive a degree of dependency between the single specified feature and each original feature of the set of original features by using a temporally first portion of the dataset;
derive a degree of dependency between all the features including the single specified feature and each engineered feature of the set of original features by using the first portion of the dataset;
identify, based on the degree of dependency associated with each original feature of the set of original features and associated with each engineered feature of the set of engineered features, an original feature or an engineered feature associated with the highest degree of dependency as the at least one feature of the dataset that is most closely dependent to the single specified feature; and
transmit, to the requesting device, an indication of the at least one feature.

9. The system according to claim 8, wherein the processor is further configured to:
analyze the received request to determine whether the received request includes a request to identify a combination of a probabilistic model based on machine learning (ML) and a set of hyperparameters as most optimized for generating a forecast for the single specified feature from among a set of combinations of ML-based probabilistic models and corresponding hyperparameters.

10. The system according to claim 9, wherein the processor is further configured to:
determine that the received request includes a request to identify a combination of a probabilistic model based on ML and a set of hyperparameters as most optimized for generating a forecast for the single specified feature from among the set of combinations.

11. The system according to claim 10, wherein the processor is further configured to:
test each combination of an ML-based probabilistic model and corresponding hyperparameters of the set of combinations to identify a combination of ML-based probabilistic model and corresponding hyperparameters that is the most optimized among the set of combinations; and
transmit, to the requesting device, an indication of the combination that is the most optimized among the set of combinations.

12. The system according to claim 8, wherein the processor is further configured to:
analyze the received request to determine whether the received request includes a request to generate the probabilistic forecast for the single specified feature.

13. The system according to claim 12, wherein the processor is further configured to:
determine that the received request includes a request to generate the forecast.

14. The system according to claim 13, wherein the processor is further configured to:
generate the forecast for the single specified feature, wherein the forecast specifies a probability distribution; and
transmit, to the requesting device, an indication of the combination that is the most optimized among the set of combinations.

15. A non-transitory computer readable medium configured to store instructions for generating a probabilistic time series forecast based on stochastic data, the instructions, when executed, cause a processor to perform the following:
receiving, from a requesting device, a request to identify at least one feature of a dataset that is most closely correlated to a single feature specified in the received request, wherein the dataset comprises the probabilistic data of the time series;
identifying a set of original features that are present within the dataset;
deriving a set of engineered features based on the set of original features;
deriving a degree of dependency between the single specified feature and each original feature of the set of original features by using a temporally first portion of the dataset;
deriving a degree of dependency between all the features including the single specified feature and each engineered feature of the set of original features by using the first portion of the dataset;
identifying, based on the degree of dependency associated with each original feature of the set of original features and associated with each engineered feature of the set of engineered features, an original feature or an engineered feature associated with the highest degree of dependency as the at least one feature of the dataset that is most closely dependent to the single specified feature; and
transmitting, to the requesting device, an indication of the at least one feature.

16. The non-transitory computer readable medium according to claim 15, wherein the instructions, when executed cause the processor to further perform the following:
analyzing the received request to determine whether the received request includes a request to identify a combination of a probabilistic model based on machine learning (ML) and a set of hyperparameters as most optimized for generating a forecast for the single specified feature from among a set of combinations of ML-based probabilistic models and corresponding hyperparameters.

17. The non-transitory computer readable medium according to claim 16, wherein the instructions, when executed cause the processor to further perform the following:
determining that the received request includes a request to identify a combination of a probabilistic model based on ML and a set of hyperparameters as most optimized for generating a forecast for the single specified feature from among the set of combinations.

18. The non-transitory computer readable medium according to claim 17, wherein the instructions, when executed cause the processor to further perform the following:
testing each combination of an ML-based probabilistic model and corresponding hyperparameters of the set of combinations to identify a combination of ML-based probabilistic model and corresponding hyperparameters that is the most optimized among the set of combinations; and
transmitting, to the requesting device, an indication of the combination that is the most optimized among the set of combinations.

19. The non-transitory computer readable medium according to claim 16, wherein the instructions, when executed cause the processor to further perform the following:
analyzing the received request to determine whether the received request includes a request to generate the probabilistic forecast for the single specified feature.

20. The non-transitory computer readable medium according to claim 19, wherein the instructions, when executed cause the processor to further perform the following:
determining that the received request includes a request to generate the forecast;
generating, in response to determining, the forecast for the single specified feature, wherein the forecast specifies a probability distribution; and
transmitting, to the requesting device, an indication of the combination that is the most optimized among the set of combinations.
